(19) United States
(12) Patent Application Publication
(10) Pub. No.: US 2016/0232309 A1
(43) Pub. Date: Aug. 11, 2016

(54) APPARATUS AND METHOD FOR ASSESSING EFFECTS OF DRUGS BASED ON NETWORKS

(71) Applicant: GACHON UNIVERSITY OF INDUSTRY-ACADEMIC COOPERATION FOUNDATION, Gyeonggi-do (KR)

(72) Inventors: Youngmi YOON, Gyeonggi-do (KR); Min OH, Gyeonggi-do (KR); Jaegyoon AHN, Seoul (KR)

(73) Assignee: GACHON UNIVERSITY OF INDUSTRY-ACADEMIC COOPERATION FOUNDATION, Gyeonggi-do (KR)

(21) Appl. No.: 14/926,685

(22) Filed: Oct. 29, 2015

(30) Foreign Application Priority Data
Feb. 10, 2015 (KR) 10-2015-0020364

(51) Int. Cl. G06F 19/00; G06N 99/00

(52) U.S. Cl. CPC G06F 19/345; G06N 99/005

(57) ABSTRACT

Disclosed is a network-based drug efficacy-assessing method, and an apparatus. The method comprises: computing a score for association between drugs and diseases by means of at least one of drug-adjacency-based inference, disease-adjacency-based inference, and module-distance-based inference; building a classifier for determining whether the drug is associated with the disease, using machine learning in which the score is employed as a feature; and determining the association between the drug and the disease by use of the classifier. The method and apparatus can search for drug-disease relation in which a drug can exert its pharmaceutical efficacy on a disease on the basis of a network constructed from protein interaction databases and protein-gene association databases, and can evaluate the molecular interaction of the drug to find out new pharmaceutical effects of the drug with higher precision and sensitivity, whereby a time and cost for the development of new drugs can be reduced.

### BACKGROUND OF THE INVENTION

1. Field of the Invention

The present disclosure relates to a network-based, drug efficacy-assessing apparatus, and a method using the same. More particularly, the present disclosure relates to an apparatus and a method for assessing a drug efficacy on a disease on the basis of a network constructed from protein interaction databases and protein-gene association databases.

2. Description of the Related Art

Association at a molecular level between a drug and a disease on which the drug exerts a pharmaceutical effect plays a critical role in the prediction of new drug indications. In order to decipher how drugs exert their effect on diseases at a molecular level, it is important to understand how a drug acts on targets related to a disease phenotype, how a gene module causes an abnormal phenotype, and how, in consequence, the targets and causative genes interact with each other. Currently, computational methods to predict potential drug-disease interactions have been arising as a drug-centric approach, a disease-centric approach, and a drug-disease mutual approach.

With the drug-centric approach, opportunities are sought to repurpose drugs using accumulated chemical or pharmaceutical knowledge. However, many physiological effects cannot be predicted by chemical properties alone because drugs undergo complex, largely uncharacterized metabolic transformations as they are metabolized and physiologically distributed.

The disease-centric approach mainly utilizes the characteristics of diseases from the perspective of disease management, symptomatology, or pathology. This approach builds a group of diseases by incorporating established knowledge about diseases, or it finds and uses the common characteristics of diseases associated with an existing drug. This disease-only-based approach relies heavily on data denoting the characteristics of diseases, and it can be affected by the quality of the data. Therefore, outcomes could be restricted according to the means used to measure gene expression profiles or phenotypic profiles, which represent the characteristics of diseases.

The drug-disease mutual approach is a combination of the two approaches described above. It can infer new therapeutic relationships between drugs and diseases by directly matching the biomolecular or chemical properties of drugs, or processed data pertaining to these properties, with the property data or processed data of diseases. Utilizing knowledge of both drugs and diseases can be a complementary and successful strategy; in particular, this approach can overcome missing knowledge with regard to the pharmacology of a drug, such as unknown or additional targets.

Among drug-disease mutual approaches, one study is to directly match the properties of drugs and diseases and to construct a signature of a drug and a signature of a disease using gene expression microarrays. Another attempt introduces the concept of a co-module, which is a representation of a drug-gene-disease relationship. In addition, a drug-disease mutual approach was suggested to construct drug-drug and disease-disease similarity measures and to exploit these measures to construct classification features, based on the observation that similar drugs are indicated for similar diseases. For reproducible implementation, however, it is limited to gathering all the required properties of drugs and diseases.

With the increasing number and variety of high-throughput datasets, functional genetic networks are becoming more accurate and complete. These networks make it possible to understand how drugs and diseases are associated at the molecular level. There is therefore a need for a technique in which the network features of drug-disease associations can be properly selected, whereby novel indications or side effects of existing drugs can be inferred with increased accuracy, thus providing more concrete evidence.

### RELATED ART DOCUMENT

### Patent Document

Korean Patent Unexamined Application Publication No. 10-2005-0085778 (issued on Aug. 29, 2005, titled “Enhanced Computer-Assisted Medical Data Progressing System and Method”, Claim 1).

### SUMMARY OF THE INVENTION

It is an object of the present disclosure to provide an apparatus and a method for assessing a drug efficacy on a disease on the basis of a network constructed from protein interaction databases and protein-gene association databases.

In accordance with an aspect thereof, the present disclosure addresses a network-based, drug efficacy-assessing method, comprising: computing a score for association between a drug and a disease by means of at least one of drug-adjacency-based inference, disease-adjacency-based inference, and module-distance-based inference; building a classifier for determining whether the drug is associated with the disease, using machine learning in which the score is employed as a feature; and determining the association between the drug and the disease by use of the classifier.

In a particular embodiment, the drug adjacency-based inference is made on the hypothesis that if there is a known association between a first drug and a first disease, a second drug adjacent to the first drug would also have an association with the first disease.

In a particular embodiment, the drug-drug adjacency is calculated on the basis of the shortest distance between a target protein and a protein within the genetic network.

In a particular embodiment, the drug-drug adjacency is obtained from a sum of the shortest distances between target proteins of the first drug and between target proteins of the second drug, divided by a scaling factor, the scaling factor being determined by a number of the target proteins of the first drug and the second drug.

In a particular embodiment, the disease-adjacency-based inference stems from the hypothesis that if there is a known association between a first drug and a first disease, the first drug would have an association with a second disease adjacent to the first disease.

In a particular embodiment, the disease adjacency is computed on the basis of the shortest distance between disease gene sets in the genetic network and between disease genes in the genetic network.

In a particular embodiment, the disease adjacency is computed by dividing a sum of the shortest distances between each disease gene of disease gene sets for the first disease and each disease gene of disease gene sets for the second disease by a scaling factor, the scaling factor being determined by the number of disease gene sets for the first disease and the second disease.

In a particular embodiment, the score for the drug-disease association is computed as a geometric mean of a maximum drug adjacency between different drugs and a maximum disease adjacency between different diseases.

In a particular embodiment, the gene module-disease distance-based inference stems from the hypothesis that if there is a known association between a first drug and a first disease and a module distance score for the association of the first drug, a second drug, and the first disease is as great as or greater than a predetermined criterion, the second drug would also have an association with the first disease.

In a particular embodiment, the module distance score is determined on the basis of paths possible in the gene network between proteins in a gene module common to the first drug and the second drug, and genes in a gene set of the first disease.

In a particular embodiment, the gene module-disease distance-based inference stems from the hypothesis that if there is a known association between a first drug and a first disease and a module distance score for the association of the first and a second disease is as great as or greater than a predetermined criterion, the first drug would also have an association with the second disease.

In a particular embodiment, the module distance score is determined on the basis of paths possible in the gene network between genes in a gene module common to the first disease and the second disease, and each target protein of the first drug.

In a particular embodiment, the score for the drug-disease association is computed as a geometric mean of a maximum module distance score between a gene module common to different drugs and a disease and a maximum module distance score between a gene module common to different diseases and a drug.

In a particular embodiment, the classifier is built using the machine learning in which at least one of a first feature, a second feature, and a third feature, which are respective scores calculated by the drug adjacency-based inference, the disease adjacency-based inference, and the combined adjacency inference, is employed.

In a particular embodiment, the classifier is built using the machine learning in which at least one of scores from a combination of: a level at which the gene module is extracted; a length of the path on the genetic network, considered for the distance between the gene module and the target disease; and interference conducted as the drug module-distance-based-inference, the disease module-distance-based-inference, and the combined inference, is used as a feature.

In accordance with another aspect thereof, the present disclosure addresses a network-based, drug efficacy-assessing apparatus, comprising: an association scoring unit for scoring a degree of the drug-disease association by means of drug- or disease-adjacency-based inference, inference based on a distance between a gene module and a disease, or both; a machine learning unit for building a classifier for determining the association between a drug and a disease, using machine learning in which the score is regarded as a feature; and an association determining unit for determining association between a drug and a disease, using the classifier.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a network-based, drug efficacy-assessing method according to some embodiments of the present disclosure;

FIG. 2 is a view illustrating the basic idea of drug- or disease-adjacency-based inference from which the network-based, drug efficacy-assessing method according to some embodiments of the present disclosure is deduced;

FIG. 3 is a view illustrating inference based on a distance between a gene module and a disease from which the network-based, drug efficacy-assessing method according to some embodiments of the present disclosure is embodied;

FIG. 4 is a block diagram of a network-based, drug effect-assessing apparatus according to some embodiments of the present disclosure; and

FIG. 5 is a view of association between a drug and a disease as determined according to the method of the present disclosure.

### DESCRIPTION OF THE PREFERRED EMBODIMENTS

Hereinafter, exemplary embodiments of the present invention will be described in detail with reference to the accompanying drawings. It should be noted that the drawings are not to precise scale and may be exaggerated in thickness of lines or size of components for descriptive convenience and clarity. Furthermore, the terms used herein are defined by taking functions of the present invention into account and can be changed according to the custom or intention of users or operators. Therefore, definition of the terms should be made according to the overall disclosures set forth herein.

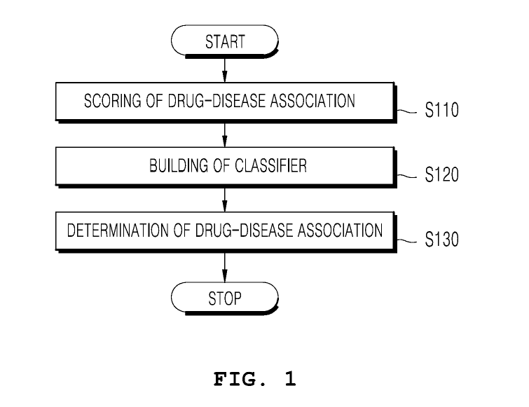

FIG. 1 is a flow chart illustrating a network-based, drug efficacy-assessing method according to some embodiments of the present disclosure.

As can be seen, the network-based, drug efficacy-assessing method according to some embodiments of the present disclosure proceeds first with an association scoring unit 100 for scoring a degree of the drug-disease association by means of drug- or disease-adjacency-based inference, inference based on a distance between a gene module and a disease, or both (S110). In this regard, the inference may be made from a genetic network. The genetic network comprises protein-protein interactions, and may be constructed on the basis of various databases. In the genetic network, the protein-protein interactions, whether direct or indirect interactions, may be collected from, for example, the Online Predicted human Interaction Database, and the Pathway Interaction Database. To integrate the networks from such multiple databases, proteins and genes were mapped with UniProt ID. Also, association between drugs and their target proteins can be obtained from the DrugBank. Diseases and their susceptible genes can be acquired from the Online Mendelian Inheritance in Man (OMIM). Further, known drug-disease associations can be obtained from the Compratative Toxicogenomics Database (CTD).

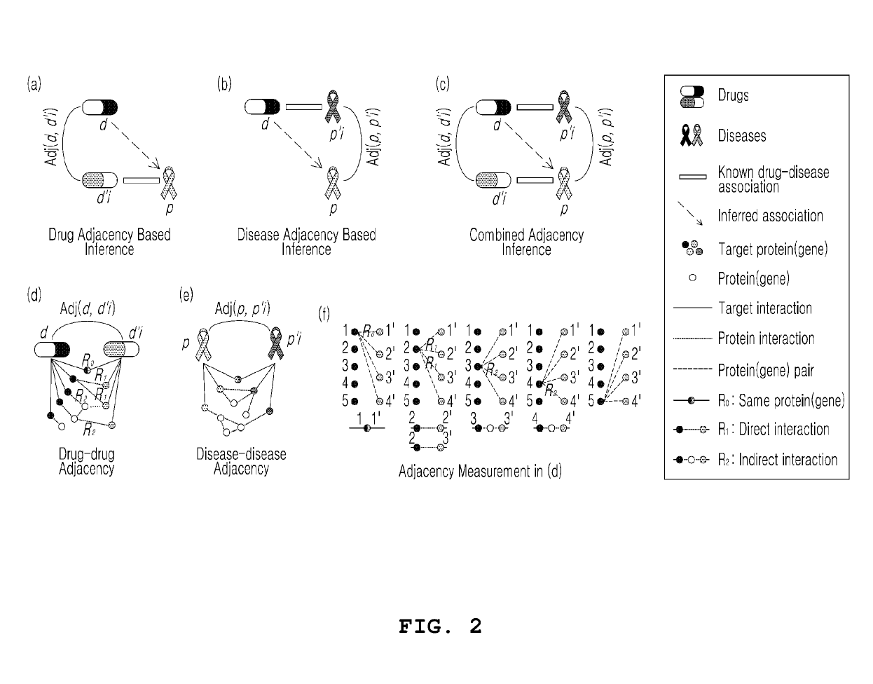

FIG. 2 is a view illustrating the basic idea of drug- or disease-adjacency-based inference from which the network-based, drug efficacy-assessing method according to some embodiments of the present disclosure is deduced.

FIG. 2(a) describes drug-adjacency-based inference. The drug-adjacency-based inference stems from the hypothesis that if there is a known association between a first drug and a first disease, a second drug adjacent to the first drug would also have an association with the first disease. Here, the drug-drug adjacency can be calculated on the basis of the shortest distance between a target protein and a protein within the genetic network. In addition, the drug-drug adjacency is obtained from a sum of the shortest distances between target proteins of the first drug and between target proteins of the second drug, divided by a scaling factor, which is the number of the target proteins of the first drug and the second drug. The drug-drug adjacency, Adj(d, d′), which accounts for adjacency between the first drug of d and the second drug of d′, is calculated according to the following Mathematical Formula 1:

$$Adj ( d , {d}^{′} ) = \frac{{\sum }_{{t}_{i} ∈ T ( d )} {\sum }_{{t}_{j} ∈ T ( {d}^{′} )} {S}_{{t}_{i} {t}_{j}}}{scaling factor} \qquad [ Mathematical Formula 1 ]$$

wherein tᵢ is a target protein of drug d in its target set T(d); tⱼ is a target protein of drug d′ in its target set T(d′); Sₜᵢ tⱼ is the shortest path between tᵢ and tⱼ in the genetic network; and scaling factor essentially denotes the number of proteins in T(d) multiplied by the number of proteins in T(d′), which allows the drug adjacency score (Adj(d, d′)) to vary from 0 to 1. In addition, the shortest path between ti and tj may be divided into three types of paths, i.e., R0, R1, and R2. Here, In R0, the proteins tᵢ and tⱼ are identical. In R1, the proteins tᵢ and tⱼ are directly connected. In R2, the proteins tᵢ and tⱼ are indirectly connected. The score of R0 may be set to the reciprocal number of median degree of a network, which is, for example, one sixth. The scores of R1 and R2 may be set to be the square of R0 and the cube of R0, respectively.

FIG. 2(b) describes the disease-adjacency-based inference approach. The disease-adjacency-based inference approach infers that if there is a known association between a first drug and a first disease, the first drug would also have an association with a second disease adjacent to the first disease. Here, the disease-disease adjacency can be calculated on the basis of the shortest distance between disease gene sets in the genetic network and between disease genes in the genetic network. That is, the disease-disease adjacency is obtained from a sum of the shortest distances between each disease gene of disease gene sets for the first disease and each disease gene of disease gene sets for the second disease, divided by a scaling factor, which accounts for the number of disease gene sets for the first and the second disease. The disease-disease adjacency is calculated according to the following Mathematical Formula 1 in which T(d) is a disease gene set of disease d, T(d′) is a disease gene set of disease d′, and S_{ti tj} is as defined above.

Also, as shown in FIG. 2(c), a degree of drug-disease adjacency can be assessed from a combination of drug-adjacency-based inference and disease-adjacency-based inference.

The adjacency score for association between drug d and disease p can be computed according to the following Mathematical Equation 2:

$$A ( d , p ) = {max}_{1 \leq k \leq n} ( Adj ( d , {d}_{k}^{′} ) ) d \neq {d}_{k}^{′} \qquad [ Mathematical Equation 2 ]$$

wherein, n is the number of drugs that have a known association with disease p. Further, disease-disease adjacency scores for association between drug d and disease p can be calculated in a similar manner using Mathematical Formula 2. That is, among the drug-drug adjacency scores for multiple drugs, the maximum value becomes the final score for the association between d and p. Here, the scores for the association between d and p from the drug-drug and disease-disease adjacency scores are combined into a single score by computing their weighted geometric mean. The drug-disease association can be obtained as C(d,p) according to Mathematical Formula 3.

C(d,p)=\sqrt{A_{D}(d,p)×A_{P}(d,p)} [Mathematical Formula 3]

wherein, A_{D}(d, p) indicates a maximum drug-drug adjacency score for association between drug d and disease p as calculated according to Math Equation 2, and A_{P}(d, p) values indicates a maximum disease-disease adjacency score for association between drug d and disease p as calculated in a similar manner.

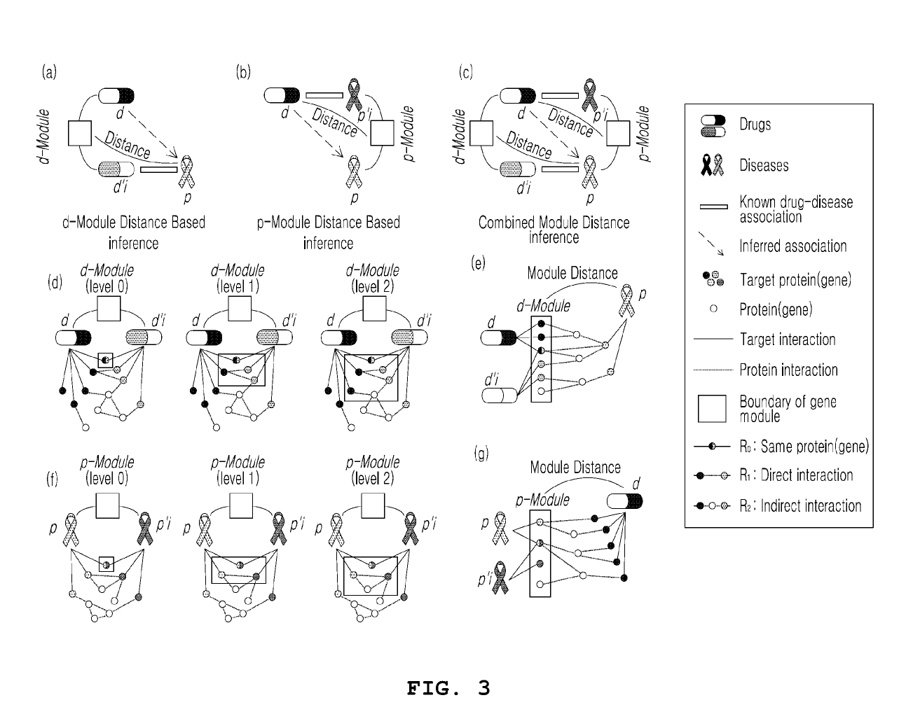

FIG. 3 is a view illustrating inference based on a distance between a gene module and a disease from which the network-based, drug efficacy-assessing method according to some embodiments of the present disclosure is embodied. As used herein, the term “module” means a topologically related gene set. The module that is shared by two drugs is extracted for a particular disease. One drug is from a known drug-disease association and the other is among the candidate drugs for the disease. This module common to two drugs is called d-Module (drug-drug gene module). In a similar manner, a module that is common to two diseases is called p-Module (disease-disease gene module). As shown in FIGS. 3(c) and 3 (d), the d-Module is extracted according to the level parameter v that is set to range from 0 to 2. The d-Module in level 0 is composed of the same proteins or genes common to two drugs or two diseases. In the module of level 1, proteins or genes common to two drugs or diseases are linked by direct interaction. The module of level 2 comprises proteins or genes that are common to two drugs or diseases and which are linked by indirect interaction.

FIG. 3(a) describes d-Module-distance-based inference. It stems from the hypothesis that if there is a known association between a first drug and a first disease, and a module distance score for the association of the first drug, a second drug, and the first disease is as great as or greater than a predetermined criterion, the second drug would also have an association with the first disease.

Here, the module distance score can be determined on the basis of paths possible in the gene network between proteins in the d-Module, that is, a gene module common to the first drug and the second drug, and genes in a gene set of the first disease.

FIG. 3(b) describes p-Module-distance-based inference. It stems from the hypothesis that if there is a known association between a first drug and a first disease, and a module distance score for the association of the first and a second disease is as great as or greater than a predetermined criterion, the first drug would also have an association with the second disease. Here, the module distance score can be determined on the basis of paths possible in the gene network between genes in the p-Module, that is, a gene module common to the first disease and the second disease, and each target protein of the first drug.

In addition, as depicted in FIG. 3(c), inference based on a distance between a gene module and a disease may be elicited from a combination of the d-Module-distance-based-inference and the p-Module-distance-based-inference.

In this regard, the module distance score can be determined from a sum of the scores of individual paths possible in the gene network between proteins in the gene module common to the first drug and the second drug and genes in a gene set of the first disease, divided by a scaling factor, which accounts for the product of the number of diseases in the common gene module and the number of the target proteins of the first drug.

Given the d-Module distance Mdis(d,d′) for drugs d and d′ and disease p, is computed according to the following Mathematical Formula 4:

$$Mdis ( d , {d}^{′} ) = \frac{{\sum }_{{t}_{i} ∈ {Mod}_{v} ( d , {d}^{′} )} {\sum }_{{g}_{j} ∈ T ( p )} {S}_{{t}_{i} {g}_{j}}^{k}}{scaling factor} \qquad [ Mathematical Formula 4 ]$$

wherein, tᵢ is a protein of d-Module Modᵥ(d, d′) and gⱼ is a gene of disease p; v represents a level at which module Modᵥ(d,d′) is extracted; scaling factor essentially denotes the number of proteins in Modᵥ(d, d′) multiplied by the number of genes in the gene set T(p) of disease p, which allows Modᵥ(d, d′) to vary from 0 to 1. Also, S_{ti gi}^{k} is the score of the path between tᵢ and gⱼ; and k is a fixed length of the path. In the case of k=0, only the intersections between tᵢ and gⱼ receive a score. When k=1, only the paths whose length is one receive a score. At k=2, only the paths whose length is two are scored.

Also, the module distance score for two diseases can be computed in a similar manner. That is, the module distance score can be determined from a sum of the scores of individual paths possible in the gene network between genes in the gene module common to the first disease and the second diseases and target proteins of the first drug, divided by a scaling factor, which accounts for the product of the number of proteins in the common gene module and the number of the genes in the gene sets of the diseases.

Here, the path score S_{ti gi}^{k} may be given the following Mathematical Formula 5:

$${S}_{{t}_{i} {g}_{j}}^{k} = \{ \begin{matrix}R 0 & if k = 0 \\ R 1 & if k = 1 \\ R 2 & if k = 2\end{matrix} \qquad [ Mathematical Formula 5 ]$$

The score of R0 may be set to be the inverse number of median degree of a network, which is one sixth. Scores of R1 and R2 may be set to be the square of R0 and the cube of R0, respectively. That is, in the case where the fixed length of the path is zero, the path score is the inverse number of median degree of the network.

When the fixed length is 1, the path score is the square of the inverse number of median degree of the network. When the fixed length is 2, the path score is the cube of the inverse number of median degree of the network.

Among the module distances for multiple drugs, the maximum values become the final score for the association between drug d and disease p. The score for the association between drug d and disease p can be expressed according to the following Mathematical Formula 6:

$$M ( d , p ) = {max}_{1 \leq i \leq n} ( Mdis ( d , {d}_{i}^{′} ) ) d \neq {d}_{i}^{′} \qquad [ Mathematical Formula 6 ]$$

wherein n denotes the number of drugs with a known association with disease p. When the d-Module of drugs d and d′ is closely related to the disease genes, it can be expected that the two drugs show a similar biological function and are highly likely to exert pharmaceutical effects on the same disease. That is, Mathematical Formula 6 accounts for drug-disease association calculated on the basis of d-Module distances. In addition, the maximum of the module distance scores for multiple diseases can be computed for association between drug d and disease p on the p-Module distance-based-inference. Here, MD(d, p) indicates drug-disease association as computed by the d-module distance-based inference according to Mathematical Formula 6, and Mp(d, p) indicates drug-disease association as computed by the p-module distance-based inference in a manner similar to Mathematical Formula 6. The combined module-distance inference method is a combination of the previously described d-module distance-based inference and the p-module distance-based inference methods, as expressed by the following Mathematical Formula 7:

C(d,p)=\sqrt{M_{D}(d,p)×M_{P}(d,p)} [Mathematical Formula 7]

A score for association between drug and disease can be computed as a geometric mean of a maximum module distance score between a gene module common to different drugs and a disease and a maximum module distance score between a gene module common to different diseases and a drug.

Next, a classifier is built by a machine learning unit 200 using Machine Learning in which the scores for the degree of the drug-disease association are regarded as features characterizing the drug-disease relationship (S120). As the features used for the machine leaning to build the classifier, A_{D}(d,p), A_{P}(d,p), and C(d,p) of Mathematical Formula 3, calculated by drug adjacency- or disease adjacency-based inference may be employed. That is, the machine learning may employ at least one of a first feature, a second feature, and a third feature, which are respective scores calculated by the drug adjacency-based inference, the disease adjacency-based inference, and the combined adjacency inference.

Further, M_{D}(d,p), M_{P}(d,p), and C(d,p) of Mathematical Formula 7, computed by gene module-disease distance-based inference, may be used as features for the machine learning to build a classifier. The three scores of Mathematical Formula 7 may be used as additional features for each of the level parameter v and the path length parameter k. In this regard, of the scores from a level at which the gene module is extracted, a length of the path on the genetic network, considered for the distance between the gene module and the target disease, the d-Module-distance-based-inference, the p-Module-distance-based-inference, and the combined inference, at least one may be used as a feature for the machine learning.

In some embodiments of the present disclosure, 27 features can be established because each of the level parameter v and the distance parameter k are set to be 0, 1, or 2, and there are 3 possible inference methods. Each drug-disease pair has 30 features overall, including the 3 features, the first to the third feature from the drug or disease adjacency-based inference. Accordingly, the machine learning in step (S120) can build classifiers, using a total of 30 features.

Subsequently, the process is terminated when an association determining unit 300 determines association between a drug and a disease using the classifiers (S130). The association determining unit 300 performs not only the determination of association between a given drug and a disease, but also searches for target diseases of a given drug from databases and repetitively determines whether there is association between the diseases and the drug, thus excavating new diseases to which the drug can exert its efficacy.

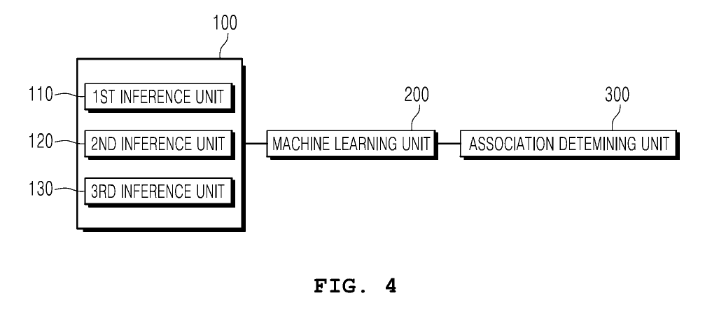

FIG. 4 is a block diagram of a network-based, drug effect-assessing apparatus according to some embodiments of the present disclosure. As can be seen in FIG. 4, the network-based, drug effect-assessing apparatus may comprise an association scoring unit 100, a machine learning unit 200, and an association determining unit 300.

The association scoring unit 100 is designed to score a degree of the drug-disease association by means of drug- or disease-adjacency-based inference, inference based on a distance between a gene module and a disease, or both. The association scoring unit 100 comprises a first inference unit 110 for performing inference on the basis of drug adjacency, a second inference unit 120 for performing inference on the basis of disease adjacency, and a third inference unit for performing inference on the basis of a distance between a gene module and a disease. The association scoring unit 100 allows for computing a degree of the association between a drug and a disease, using the method of step (S110).

Using machine learning in which the association score is regarded as a feature, the machine learning unit 200 builds a classifier for determining the association between a drug and a disease. Here, the machine learning unit can generate a classifier on the basis of the method of step (S120).

The association determining unit 300 is designed to determine association between a drug and a disease, using the classifier. According to the step (S130), the association determining unit 300 determines whether a drug is associated with a disease or not. The association determining unit 200 performs not only the determination of association between a given drug and a disease, but also searches for target diseases of a given drug from databases and repetitively determines whether there is association between the diseases and the drug, thus discovering new diseases to which the drug can exert its efficacy.

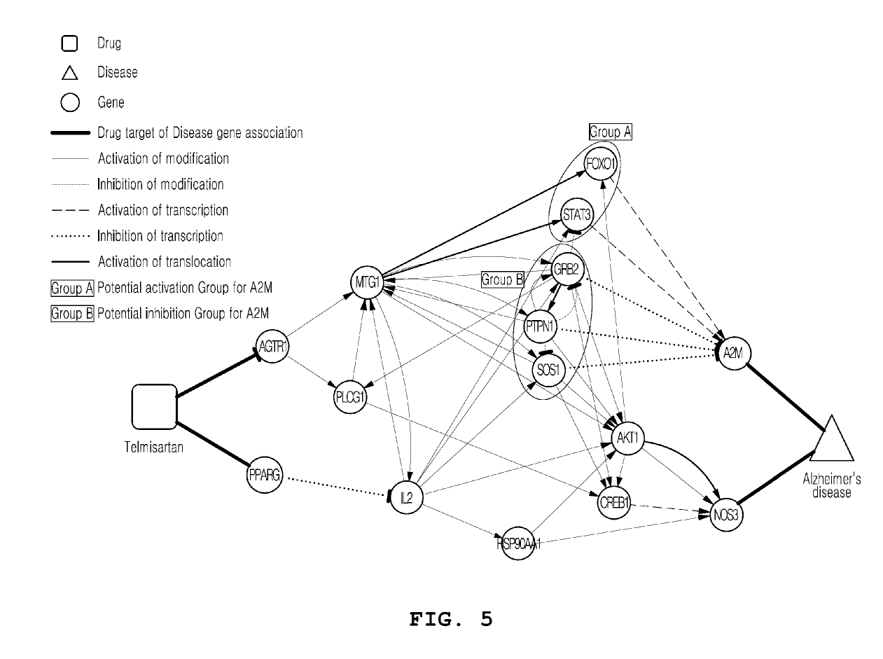

FIG. 5 is a view of association between a drug and a disease as determined according to the method of the present disclosure. Telmisartan is a therapeutic agent for hypertension. As can be seen in FIG. 5, telmisartan can be determined to have association with Alzheimer's disease, indicating that telmisartan is a candidate that might be therapeutic for Alzheimer's disease.

As described hitherto, the method of the present disclosure can search for drug-disease relation in which a drug can exert its pharmaceutical efficacy on a disease on the basis of a network constructed from protein interaction databases and protein-gene association databases, and can evaluate the molecular interaction of the drug to find out new pharmaceutical effects of the drug with higher precision and sensitivity, whereby a time and cost for the development of new drugs can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A network-based, drug efficacy-assessing method, comprising:
computing a score for association between a drug and a disease by means of at least one of drug-adjacency-based inference, disease-adjacency-based inference, and module-distance-based inference;
building a classifier for determining whether the drug is associated with the disease, using machine learning in which the score is employed as a feature; and
determining the association between the drug and the disease by use of the classifier.

2. The network-based, drug efficacy-assessing method of claim 1, wherein the drug adjacency-based inference is made on the hypothesis that if there is a known association between a first drug and a first disease, a second drug adjacent to the first drug would also have an association with the first disease.

3. The network-based, drug efficacy-assessing method of claim 1, wherein the drug-drug adjacency is calculated on the basis of the shortest distance between a target protein and a protein within the genetic network.

4. The network-based, drug efficacy-assessing method of claim 3, wherein the drug-drug adjacency is obtained from a sum of the shortest distances between target proteins of the first drug and between target proteins of the second drug, divided by a scaling factor, the scaling factor being determined by a number of the target proteins of the first drug and the second drug.

5. The network-based, drug efficacy-assessing method of claim 1, wherein the disease-adjacency-based inference stems from the hypothesis that if there is a known association between a first drug and a first disease, the first drug would have an association with a second disease adjacent to the first disease.

6. The network-based, drug efficacy-assessing method of claim 1, wherein the disease adjacency is computed on the basis of the shortest distance between disease gene sets in the genetic network and between disease genes in the genetic network.

7. The network-based, drug efficacy-assessing method of claim 6, wherein the disease adjacency is computed by dividing a sum of the shortest distances between each disease gene of disease gene sets for the first disease and each disease gene of disease gene sets for the second disease by a scaling factor, the scaling factor being determined by the number of disease gene sets for the first disease and the second disease.

8. The network-based, drug efficacy-assessing method of claim 1, wherein the score for the drug-disease association is computed as a geometric mean of a maximum drug adjacency between different drugs and a maximum disease adjacency between different diseases.

9. The network-based, drug efficacy-assessing method of claim 1, wherein the gene module-disease distance-based inference stems from the hypothesis that if there is a known association between a first drug and a first disease and a module distance score for the association of the first drug, a second drug, and the first disease is as great as or greater than a predetermined criterion, the second drug would also have an association with the first disease.

10. The network-based, drug efficacy-assessing method of claim 9, wherein the module distance score is determined on the basis of paths possible in the gene network between proteins in a gene module common to the first drug and the second drug, and genes in a gene set of the first disease.

11. The network-based, drug efficacy-assessing method of claim 1, wherein the gene module-disease distance-based inference stems from the hypothesis that if there is a known association between a first drug and a first disease and a module distance score for the association of the first and a second disease is as great as or greater than a predetermined criterion, the first drug would also have an association with the second disease.

12. The network-based, drug efficacy-assessing method of claim 1, wherein the module distance score is determined on the basis of paths possible in the gene network between genes in a gene module common to the first disease and the second disease, and each target protein of the first drug.

13. The network-based, drug efficacy-assessing method of claim 1, wherein the score for the drug-disease association is computed as a geometric mean of a maximum module distance score between a gene module common to different drugs and a disease and a maximum module distance score between a gene module common to different diseases and a drug.

14. The network-based, drug efficacy-assessing method of claim 1, wherein the classifier is built using the machine learning in which at least one of a first feature, a second feature, and a third feature, which are respective scores calculated by the drug adjacency-based inference, the disease adjacency-based inference, and the combined adjacency inference, is employed.

15. The network-based, drug efficacy-assessing method of claim 1, wherein the classifier is built using the machine learning in which at least one of scores from a combination of:
a level at which the gene module is extracted;
a length of the path on the genetic network, considered for the distance between the gene module and the target disease; and
interference conducted as the drug module-distance-based-inference, the disease module-distance-based-inference, and the combined inference, is used as a feature.

16. A network-based, drug efficacy-assessing apparatus, comprising:
an association scoring unit for scoring a degree of the drug-disease association by means of drug- or disease-adjacency-based inference, inference based on a distance between a gene module and a disease, or both,
a machine learning unit for building a classifier for determining the association between a drug and a disease, using machine learning in which the score is regarded as a feature; and
an association determining unit for determining association between a drug and a disease, using the classifier.
